(19) United States
(12) Patent Application Publication
(10) Pub. No.: US 2026/0200251 A1
(43) Pub. Date: Jul. 16, 2026

(54) HOUSING AND TAPE CARTRIDGE

(71) Applicant: ZHUHAI QUIN TECHNOLOGY CO., LTD, XIANGZHOU DIST. (CN)

(72) Inventors: Yiyin WU, XIANGZHOU DIST., ZHUHAI (CN); Xiaowei WANG, XIANGZHOU DIST., ZHUHAI (CN)

(21) Appl. No.: 19/094,179

(22) Filed: Mar. 28, 2025

(30) Foreign Application Priority Data
Jan. 13, 2025 (CN) 202520076126.0

(51) Int. Cl. B41J 15/04; B41J 3/407

(52) U.S. Cl. CPC B41J 15/044; B41J 3/4075

(57) ABSTRACT

A housing includes a first housing and a second housing connected along a thickness direction of the housing. The housing is provided with a notch, which is provided on a width side of the housing and runs through both sides of the housing's thickness; the housing includes an arm body and an identification pillar, in a length direction of the housing, the arm body is adjacent to the notch and faces away from a center of the housing relative to the notch, the identification pillar protrudes from the arm body; the first housing includes a first arm part, the second housing includes a second arm part, and the arm body is formed by connecting the first arm part and the second arm part along the thickness direction; the first arm part and/or the second arm part are/is configured as a cavity-housing structure. A tape cartridge includes the above-mentioned housing.

### CROSS-REFERENCE TO RELATED APPLICATIONS

This application claims priority to Chinese Patent Application No. 202520076126.0, filed on Jan. 13, 2025, which is hereby incorporated by reference in its entirety.

### TECHNICAL FIELD

The present disclosure relates to the field of printing consumable technology and, in particular, to a printing consumable tape cartridge of a label printer and its housing.

### BACKGROUND

In the field of printing equipment, a housing structure is usually manufactured by using an injection molding process. In order to reduce production costs and minimize material consumption, various optimization designs are made by designers on the housing structure, such as adjusting wall thickness, arranging reinforcement plates, creating weight reducing structures, and reasonably arranging functional structures, and so on. These optimization designs can effectively reduce raw material costs while ensuring the basic functionality of the housing.

However, in a practical application, it has been found that excessive pursuit of material saving may affect the structural strength and overall performance of a product. Especially in areas with high load-bearing stress or requiring precise positioning, if the structural design is not reasonable enough, it is easy to deform due to insufficient local strength during use, thereby affecting the functional implementation of the product.

Therefore, when designing the housing structure, it is necessary to comprehensively weigh multiple aspects such as cost control, process implementation, and product performance to ensure that the product can maintain good cost-effectiveness and stably and reliably works with its expected functions, which has become an urgent problem to be solved in this field.

### SUMMARY

A first objective of the present disclosure is to provide a housing that improves bending strength of an arm body.

A second objective of the present disclosure is to provide a tape cartridge that improves the bending strength of the arm body to ensure an effective identification pillar.

A housing provided by the first objective of the present disclosure, includes: a first housing and a second housing which are connected to each other along a thickness direction of the housing; the housing is provided with a notch, and the notch is provided on a width side of the housing and runs through both sides of the housing's thickness; the housing includes an arm body and an identification pillar, and in a length direction of the housing, the arm body is adjacent to the notch and faces away from a center of the housing relative to the notch, and at least one of the identification pillar protrudes from the arm body; the first housing includes a first arm part, the second housing includes a second arm part, and the arm body is formed by connecting the first arm part and the second arm part along the thickness direction; and at least one of the first arm part and the second arm part is configured as a cavity-housing structure.

As can be seen from the above solution, the cavity-housing structure includes at least two wall bodies with different orientations, edges of multiple wall bodies being integrally formed and having different orientations are connected to each other to form a housing. Thickness of the wall body is thicker, and due to the connection between the wall bodies in different directions, the cavity-housing structure has better bending strength compared to a single thin wall plate. The two arm parts on the first housing and the second housing are docked and merged into the arm body, and at least one arm body adopts a cavity-housing structure. The arm body has a thicker thickness in the thickness direction of the housing, and the cavity-housing structure has better strength, ensuring bending deformation resistance of the arm body, and thus ensuring that identification of the identification pillar in the abut state is continuously effective, and reducing the overall material consumption due to the formation of a cavity housing.

A further solution is that, one of the first arm part and the second arm part is configured as a cavity-housing structure, and the other of the first arm part and the second arm part is configured as a wall panel.

As can be seen from the above, under the premise of configuring one of the arm parts as a cavity-housing structure to meet strength requirements, configuring the other one of the arm parts as a wall panel can further save materials.

A still further solution is that, the housing further includes a first connecting pillar and a first seating hole; the first connecting pillar is connected to one of the first arm part and the second arm part, and the first seating hole is connected to the other of the first arm part and the second arm part, the first connecting pillar is mated with the first seating hole along the thickness direction, and both the first connecting pillar and the first seating hole are located inside the arm body.

As can be seen from the above, when one of the arm parts is configured as a wall panel, the strength and deformation resistance of the wall panel itself is still poor. If the wall panel is only adjacent to the cavity housing of the other arm part without any other connection relationship, the wall panel may still undergo irreversible deformation under additional force, such as accidental scratching or after being pulled by fingers. For this purpose, the structural connection between the wall panel and the cavity-housing structure is strengthened through the connecting pillar and the seating hole.

Another further solution is that, the housing further includes a second connecting pillar and a second seating hole; the first housing includes a first root part, the first root part is connected to an extension starting end of the first arm part, and the second housing includes a second root part, the second root part is connected to the extension starting end of the second arm part; the second connecting pillar is connected to one of the first root part and the second root part, and the second seating hole is connected to the other of the first root part and the second root part, the second connecting pillar is mated with the second seating hole along the thickness direction, and both the second connecting pillar and the second seating hole are located inside the housing.

As can be seen from the above, in response to limited space inside the arm body, in the present disclosure, the second connecting pillar and the second seating hole are configured at the first root part and the second root part which are provided with sufficient space and close to the arm body, which can also strengthen the connection between the first arm part and the second arm part.

A further solution is that, an extension ending end of the arm body is configured as a bending part, the bending part extends towards a direction close to the notch relative to a base of the arm body.

As can be seen from the above, compared to a straight arm body, the arm body bent at an extension ending end can make a side wall of the cavity-housing structure provide additional support force during installation. The bending extension prevents deformation of the housing, has better bending resistance performance, improves the overall stability of the housing, and can avoid excessive stress concentration during use, thereby improving the service life of the cavity-housing structure.

A still further solution is that, the base extends along a width direction of the housing, and the bending part extends along the length direction of the housing.

A still further solution is that, at least one of the identification pillar protrudes from the bending part.

As can be seen from the above, the straight arm body does not conform to distribution of the identification pillars of tape cartridges of some models. In a case where the arm body with the extension ending end is bent into an “L” shape, the requirements for saving materials are met, and the setting requirement of the identification pillars are also met.

A further solution is that, the housing includes a side wall, and the notch is formed between the side wall and the arm body, the side wall is extended in a distance in both the width direction and the length direction of the housing; the housing includes a connecting part, and a surface of the side wall, the connecting part, and the arm body are sequentially connected; the surface of the side wall, except for an area connected to the connecting part, is configured as a wall surface.

As can be seen from the above, this setting can minimize an unnecessary structural body on the surface of the side wall, making the overall structure more compact, providing high space utilization, and further saving materials for the housing.

A still further solution is that, the width side is provided with a first right-angle part, and a first end of the wall surface is connected to the first right-angle part; and/or, a length side of the housing is provided with a second right-angle part, and a second end of the wall surface is connected to the second right-angle part.

As can be seen from the above, the setting of the right-angle parts makes stress transmission more uniform, avoids the stress concentration, and thus improves the service life of the housing structure.

A yet further solution is that, at least a part of the wall surface extends along a circular arc in terms of a projection in the thickness direction; or, at least a part of the wall surface extends continuously and tortuously in terms of a projection in the thickness direction.

As can be seen from the above, the wall surface extends along a circular arc surface with a fixed diameter, or extends continuously and tortuously, both of which can make the wall surface show a trend of bending and extending from the width side to the length side of the housing, thereby optimizing an outer contour of the housing and improving its aesthetic appearance.

Another further solution is that, the housing is provided with a printing tape roll hole, and in terms of a projection in the thickness direction, the wall surface is provided on a periphery of the printing tape roll hole and covers an angle greater than or equal to 45 degrees.

As can be seen from the above, under this setting, the wall surface is concentric or nearly concentric with the printing tape roll hole, thereby creating a more coordinated visual experience and improving the aesthetic appearance.

A tape cartridge provided by the second objective of the present disclosure includes the above housing.

### BRIEF DESCRIPTION OF DRAWINGS

FIG. 1 is a structural diagram of a first embodiment of a housing of the present disclosure from a perspective of a thickness direction.

FIG. 2 is a structural diagram of the first embodiment of the housing of the present disclosure from a second perspective.

FIG. 3 is a structure exploded diagram of the first embodiment of the housing of the present disclosure.

FIG. 4 is a structural diagram of a second housing in the first embodiment of the housing of the present disclosure.

FIG. 5 is a structural diagram of the first embodiment of the housing of the present disclosure from a third perspective.

FIG. 6 is a structural diagram of the first embodiment of the housing of the present disclosure from a fourth perspective.

FIG. 7 is a structural diagram of a second embodiment of a housing of the present disclosure from a first perspective.

FIG. 8 is a structure exploded diagram of the second embodiment of the housing of the present disclosure.

FIG. 9 is a structural diagram of the second embodiment of the housing of the present disclosure from a second perspective.

FIG. 10 is an enlarged view of part A in FIG. 1.

### DESCRIPTION OF EMBODIMENTS

Below, a detailed description of embodiments of the technical solution of the present application will be provided in conjunction with the accompanying drawings. The following embodiments are only used to illustrate the technical solution of the present application more clearly, and therefore they are only examples, and cannot be used to limit protection scope of the present application.

Unless otherwise defined, all technical and scientific terms used herein have the same meanings as those commonly understood by those skilled in the art of the present application. The terms used herein are only for the purpose of describing specific embodiments and are not intended to limit the present application.

In the description of the embodiments of the present application, terms such as “first” and “second” are only used to distinguish different objects and cannot be understood as indicating or implying relative importance or implying the quantity, specific order, or primary-secondary relationship of the indicated features. In the description of the embodiments of the present application, the meaning of “multiple” refers to two or more, unless otherwise specifically limited.

In the description of the embodiments of the present application, the term “multiple” refers to two or more (including two), similarly, “multiple groups” refers to two or more groups (including two groups), and “multiple pieces” refers to two or more pieces (including two pieces).

In the description of the embodiments of the present application, the directional or positional relationships indicated by terms such as “center”, “length”, “width”, “thickness”, “inside”, “outside”, etc. are based on the directional or positional relationships shown in the accompanying drawings, only for the convenience of describing the embodiments of the present application and simplifying the description, and do not indicate or imply that the apparatuses or components referred to must have specific orientations, be constructed and operated in specific orientations, and therefore cannot be understood as limitations on the embodiments of the present application.

In the description of the embodiments of the present application, unless otherwise specified and limited, terms such as “installation”, “in connection with”, and “connection” should be broadly understood, for example, it can be fixed connections, detachable connections, or integrated connections; it can be direct connection or indirect connection through an intermediate medium, and it can be a connection within two components or an interaction relationship between two components. For those of ordinary skill in this field, the specific meanings of the above terms in the embodiments of the present application can be understood according to the specific situation.

First embodiment of a tape cartridge and first embodiment of a housing.

The tape cartridge of the present embodiment is a printing consumable tape cartridge of a label printer. The tape cartridge includes a housing and an internal structure provided in the housing, and the internal structure is implemented using the prior art.

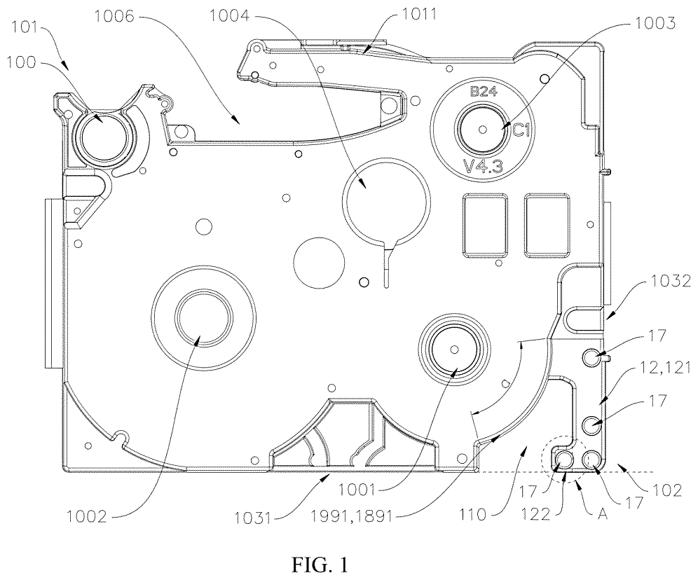

Referring to FIG. 1, FIG. 1 is a front view in a thickness direction of the tape cartridge. As shown in FIG. 1, in a direction perpendicular to the thickness direction, the direction of the tape cartridge with a larger size is a length direction of the tape cartridge and the housing, and the direction of the tape cartridge with a smaller size is a width direction of the tape cartridge and the housing. A side facing paper shown in FIG. 1 is an opposite side of the housing to a bottom wall of the printer's consumable placement position.

Seen from the thickness direction of the housing shown in FIG. 1, the housing of the tape cartridge is provided with a tape drive shaft hole 100, a printing tape roll hole 1001, an adhesive tape roll hole 1002, a carbon tape roll hole 1003, and a recycling roll hole 1004 distributed at different positions. The housing of the tape cartridge includes a first corner 101 and a second corner 102, which are located diagonally opposite each other, as shown in FIG. 1. The first corner 101 is located at an upper left corner of the housing, while the second corner 102 is located at a lower right angle of the housing. The housing of the tape cartridge includes a width side 1031 and a length side 1032. The width side 1031 refers to an outermost side of the housing in the width direction, away from the first corner 101 and close to the second corner 102. The length side 1032 refers to the outermost side of the housing in the length direction, away from the first corner 101 and close to the second corner 102; that is, the second corner 102 is the angle between the width side 1031 and the length side 1032.

The tape drive shaft hole 100 is provided on a position of the housing near the first corner 101, and is used for installing a tape drive shaft. The printing tape roll hole 1001 is provided on a position of the housing near the second corner 102, and is used for installing the printing consumable material roll. The adhesive tape roll hole 1002 is provided at a position close to a third corner of the housing, and the carbon tape roll hole 1003 is provided at a position close to a fourth corner of the housing, with the third corner being near the width side 1031 and the fourth corner being away from the width side 1031. As shown in FIG. 1, the third corner is located at the lower left corner of the housing and the fourth corner is located at the upper right corner of the housing. The adhesive tape roll hole 1002 is used for installing an adhesive tape roll, and the carbon tape roll hole 1003 is used for installing a carbon tape roll. In addition, the recycling roll hole 1004 is located in the middle of the housing and between the adhesive tape roll hole 1002 and the carbon tape roll hole 1003. The recycling roll hole 1004 is used for installing a recycling roll of a carbon tape.

In the width direction of the housing, there is a cantilever 1011 on an opposite side to the width side 1031. A starting end of the cantilever 1011 is close to the fourth corner at the upper right corner shown in FIG. 1, and the cantilever 1011 extends towards the first corner 101. In the width direction, the cantilever 1011 is spaced apart from a position where the recycling roll hole 1004 is located to form a printing head position 1006 for inserting a printing head. In the length direction, the cantilever 1011 is spaced apart from a position where the tape drive shaft hole 100 is located to form a tape feeding position which is connected to the printing head position 1006. Consumables extend from the inside of the cantilever 1011, pass through the tape feeding position, and then reach the tape drive shaft hole 100. A rubber roller and the printing head located within the printing head position 1006 can press the consumables from the opposite sides of consumables in the tape feeding position.

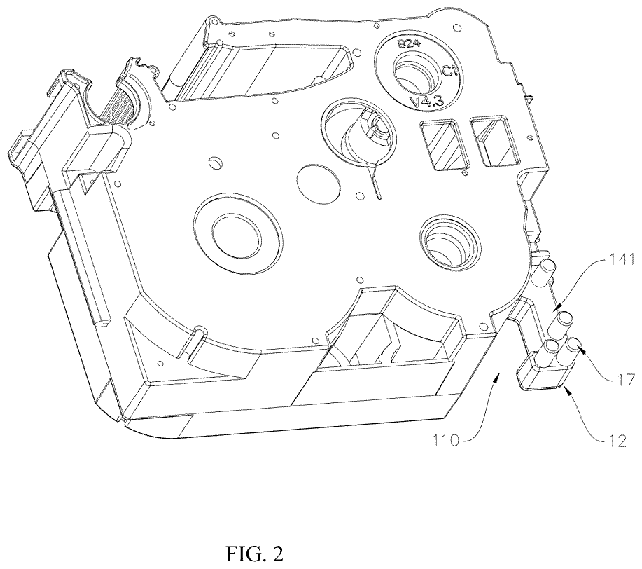

Referring to FIG. 1 and FIG. 2, an arm body 12 is provided on the second corner 102, and four identification pillars 17 are provided on and near the arm body 12. The identification pillars 17 are used to abut against identification points on the printer. The housing is provided with a notch 110, as shown in FIG. 1, and the notch 110 is provided on the width side 1031 of the housing. As shown in FIG. 2, the notch 110 runs through both sides of the housing in the thickness direction. Due to the setting of the notch 110, the above arm body 12 is formed at an adjacent position to the notch 110 in the length direction of the housing. The arm body 12 located at the second corner 102 faces away from a center of the length direction of the housing relative to the notch 110.

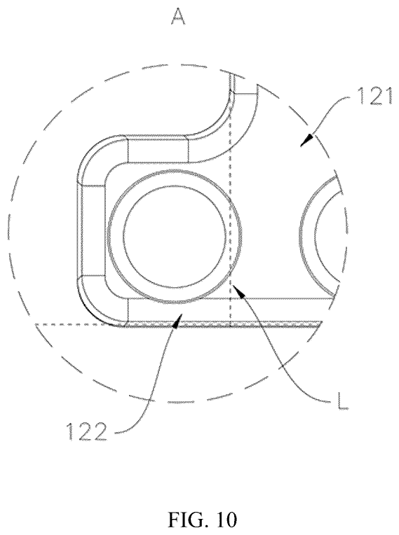

Referring to FIG. 1 and FIG. 10, in the present embodiment, the extension ending end of the arm body 12 is provided as a bending part 122. Along the width direction of the housing, an end of the arm body 12 connected to the housing body is an extension starting end of the arm body 12, and an end of the arm body 12 located on the width side 1031 away from the housing body is the extension ending end of the arm body 12. The bending part 122 extends towards a direction near an opening of the notch 110 relative to a base 121 of the arm body 12. A boundary between the base 121 and the bending part 122 is shown by a dashed line L in FIG. 1. The base 121 extends along the width direction of the housing, while the bending part 122 extends along the length direction of the housing. The bending part 122 does not refer to that such part self is bent, but refers to the bending relative to the base 121 of the arm body 12, that is, except for a bending and extended part on the extension ending end, a part extending in a straight line along the width direction is the base 121 of the arm body 12.

In addition, the extension ending end of the arm body 12 is flush with the width side 1031. In the prior art, due to the arm body being configured as a flat thin-walled plate, if a length of the arm body is too long, it will further cause problems such as easy bending or even breakage. Therefore, the arm body in the prior art is relatively short and have a certain degree of retraction relative to the width side. However, this also makes the corner where the arm body of the housing of the tape cartridge is located lack a limiting structure that can fit with the printer, which affects the installation stability of the tape cartridge. Due to the improved sufficient bending resistance of the arm body of the present disclosure, even if the extension ending end of the arm body 12 is flush with the width side, there will be no bending deformation problem, and the arm body 12 can become a limiting structure located at a corner of the tape cartridge again, forming a good supporting and cooperating relationship with the printer, thereby improving the installation stability of the tape cartridge.

Referring to FIG. 1 and FIG. 2, in the present embodiment, one identification pillar 17 is provided outside the arm body 12, two identification pillars 17 are provided on the base 121, and one identification pillar 17 is provided on the bending part 122. Specifically, the arm body 12 includes a surface 141, which is a surface on the arm body 12 for contacting the identification points of the printer in the thickness direction of the housing. The surface 141 extends beyond the extension starting end of the arm body 12, and four cylindrical identification pillars 17 protrude from the surface 141 along the thickness direction of the housing. Under this setting, the identification pillar 17 reduces, from the arm body and the thickness direction, a distance of protrusion of the identification point of the printer from the surface 141. In this way, when the identification pillar is shorter, it can have better bending resistance.

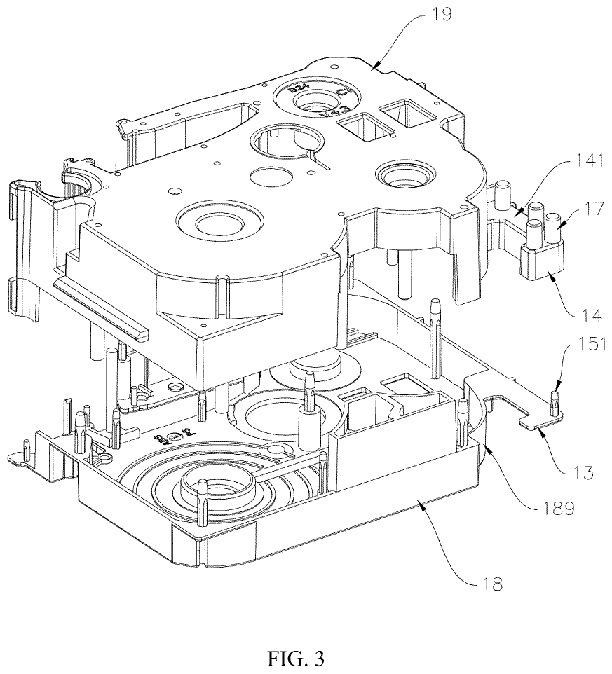

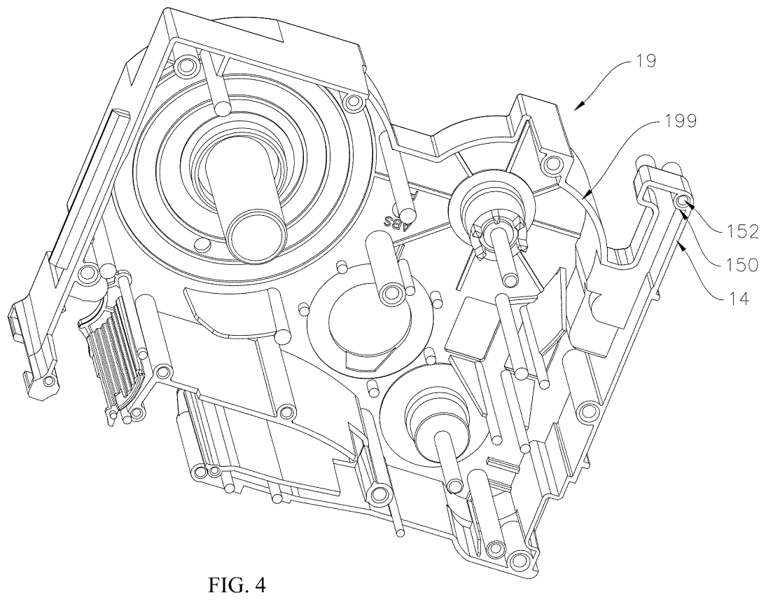

Referring to FIG. 3 and FIG. 4, the housing includes a first housing 18 and a second housing 19 which are connected to each other along the thickness direction of the housing. The first housing 18 is an integrally molded plastic housing, and the second housing 19 is also an integrally molded plastic housing. The first housing 18 includes a first arm part 13, the second housing 19 includes a second arm part 14, and the arm body 12 is formed by docking and merging the first arm part 13 and the second arm part 14 along the thickness direction. In the present embodiment, the first arm part 13 is provided as a wall panel and the second arm part 14 is provided as a cavity-housing structure.

As shown in FIG. 3, the wall panel only includes a first wall body extending along a plane perpendicular to the thickness direction of the housing.

In the present application, the cavity-housing structure includes at least two wall bodies with different orientations, multiple wall bodies are connected to form a shell, and a cavity which is open at least in the thickness direction of the housing is formed between the multiple wall bodies. As shown in FIG. 4, in the present embodiment, in addition to a second wall body extending along a plane perpendicular to the thickness direction of the housing, the cavity-housing structure of the second arm part 14 also includes a peripheral wall extending from an outer peripheral edge of the second wall body, along the thickness direction of the housing and towards the first arm part 13. The second wall body is connected to the peripheral wall to form a shell, and a cavity which is open towards the first wall body is formed between the second wall body and the peripheral wall.

Referring to FIG. 3, the first housing 18 also includes a first connecting pillar 151, which is connected to the surface of the first wall body of the first arm part 13 and extends along the thickness direction of the housing towards the second arm part 14. Referring to FIG. 4, the second housing 19 also includes a cylindrical first seating hole 150, in which a second connecting hole 152 is formed. The first seating hole 150 is connected between the second wall body of the second arm part 14 and the peripheral wall. Furthermore, the first connecting pillar 151 and the first seating hole 150 are connected to a straight extension ending end of the base of the arm body 12.

When the first housing 18 and the second housing 19 are connected along the thickness direction of the housing, the first arm part 13 and the second arm part 14 are also connected along the thickness direction of the housing to form the arm body 12. The first connecting pillar 151 and the first connecting hole 152 of the first seating hole 150 are inserted and matched along the thickness direction, and the first connecting pillar 151 and the first seating hole 150 are located inside the arm body 12. The first wall body of the first arm part 13 covers the opening of the cavity of the second arm part 14, and the two form an arm body 12 whose cavity is fully sealed. The arm body 12 has sufficient thickness and a bending connection wall body to provide sufficient bending strength, and can also reduce injection molding materials by forming a cavity.

In addition, referring to FIG. 3 and FIG. 4, the housing includes a side wall, which includes a first side wall 189 on the first housing 18 and a second side wall 199 on the second housing 19. The first side wall 189 and the second side wall 199 are docked and merged to form the side wall, and the notch 110 is formed between the side wall and the arm body 12.

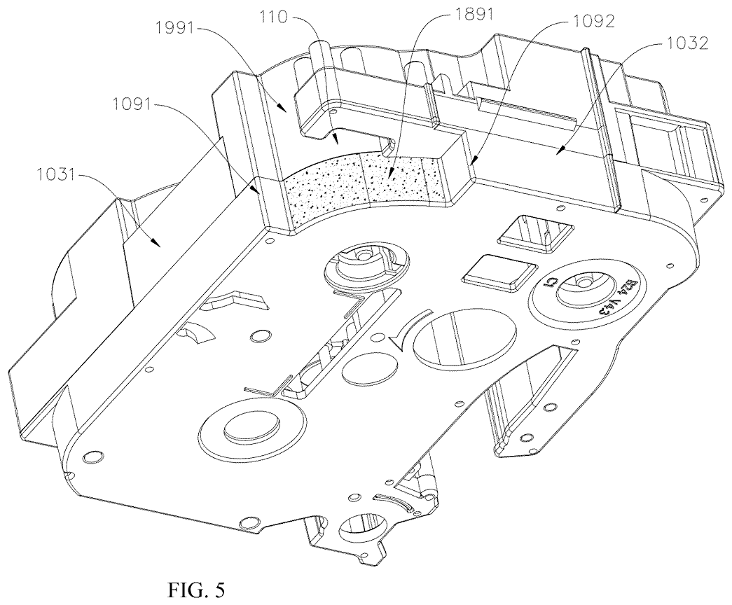

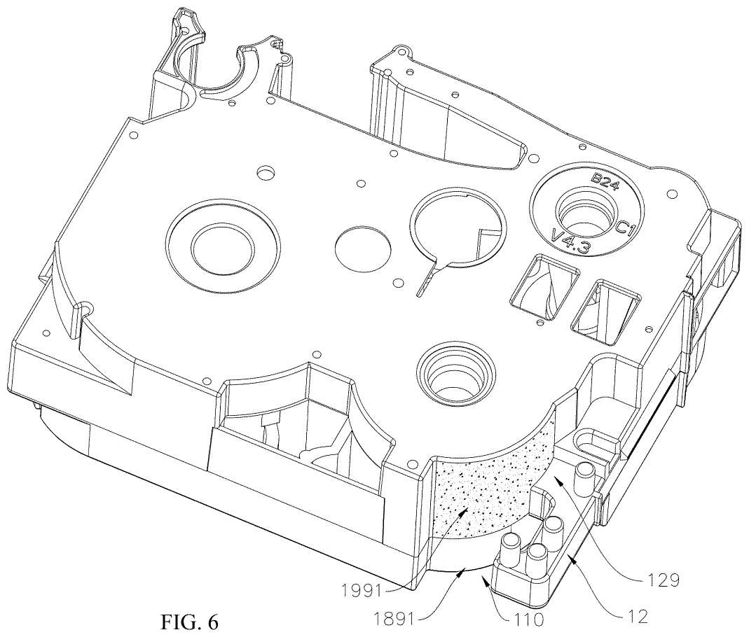

Referring to FIG. 5 and FIG. 6, the width side 1031 of the housing is provided with a first right-angle part 1091, and the length side 1032 of the housing is provided with a second right-angle part 1092. The side wall extends in a distance in both the width direction and the length direction of the housing, and extends between the first right-angle part 1091 and the second right-angle part 1092. The housing includes a connecting part 129. An outer surface of the side wall, the connecting part, and the arm body are connected in sequence. The outer surface of the side wall, except for an area connected to the connecting part 129, is configured as the above-mentioned wall surface.

Furthermore, the wall surface includes a first wall surface 1891 located on the surface side of the first side wall 189 and a second wall surface 1991 located on the surface side of the second side wall 199.

Referring to FIG. 1 and FIG. 6, the second wall surface 1991 extends along a circular arc surface, and this circular arc line is concentric with the printing tape roll hole 1001. Furthermore, referring to FIG. 5 and FIG. 6, a first end of the first wall surface 1891 and a first end of the second wall surface 1991 are both connected to the first right-angle part 1091. However, since the second right-angle part 1092 is provided only on the first housing, only a second end of the first wall surface 1891 is connected to the second right-angle part 1092. In addition, referring to FIG. 1, in terms of a projection in the thickness direction, the first wall surface 1891 and the second wall surface 1991 are provided on the periphery of the printing tape roll hole 1001 and cover an angle a greater than or equal to 45 degrees to make the visual perception of the circular arc surface more obvious. In this embodiment, the angle a is 82 degrees.

Second embodiment of a tape cartridge and second embodiment of a housing.

An actual size of a specific model corresponding to the tape cartridge in the present embodiment is smaller than an actual size of a specific model corresponding to the tape cartridge in the first embodiment.

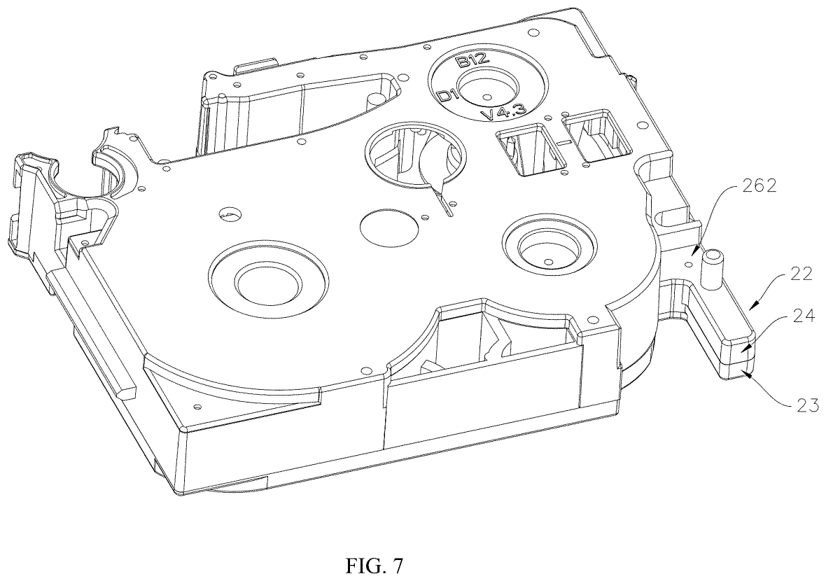

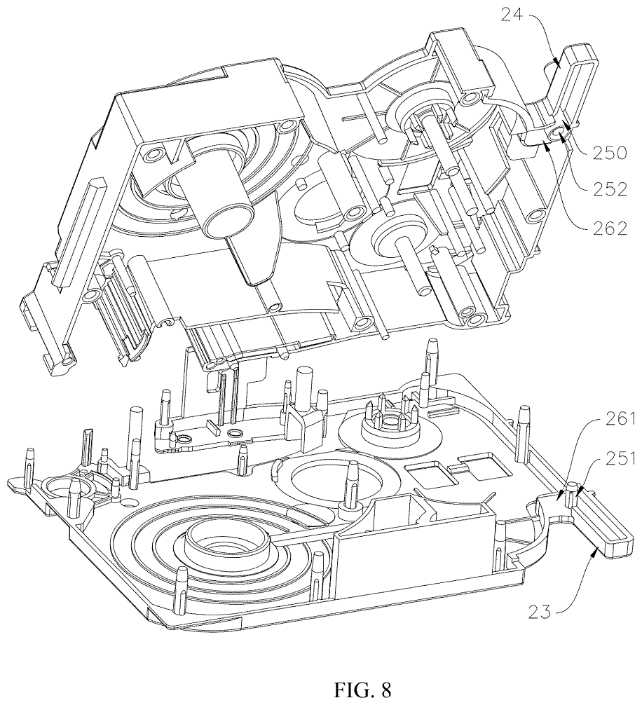

Referring to FIG. 7 and FIG. 8, unlike the first embodiment of the housing, in the present embodiment, the arm body 22 extends along the width direction of the housing to form a straight line shape and does not have the bending part 122 as in the first embodiment. In the present embodiment, both the first arm part 23 and the second arm part 24 adopt a cavity-housing structure. In the present embodiment, the housing includes only one identification pillar connected to the second arm part 24.

In the present embodiment, the first arm part 23 and the second arm part 24 are not provided with the connected first connecting pillar and first connecting hole, but the housing of the present embodiment includes a second connecting pillar 251 and a second seating hole 250 provided outside the arm body 22. Specifically, the first housing includes a first root part 261, which is connected to an extension starting end of the first arm part 23. The second connecting pillar 251 extends along the thickness direction from a surface of the first root part 261 facing the second housing. The second housing includes a second root part 262 which is connected to an extension starting end of the second arm part 24. The second seating hole 250 is provided in the cavity of the second root part 262, and a second connection hole 252 facing the first housing is provided in the second seating hole 250. The second connecting pillar 251 and the second connecting hole 252 are inserted and matched along the thickness direction of the housing. After the first housing and the second housing are connected to form the housing, both the second connecting pillar 251 and the second connecting hole 252 are located inside the housing. When the tape cartridge is of a smaller size and both arm parts adopt a cavity-housing structure, it is difficult to set a larger seating hole in the smaller space inside the arm cavity. In response to this situation, the second connecting pillar 251 and the second seating hole 250 are respectively provided to the first root 261 and the second root 262 which are provided with sufficient space and close to the arm body 22, which can also strengthen a connection between the first arm part 23 and the second arm part 24.

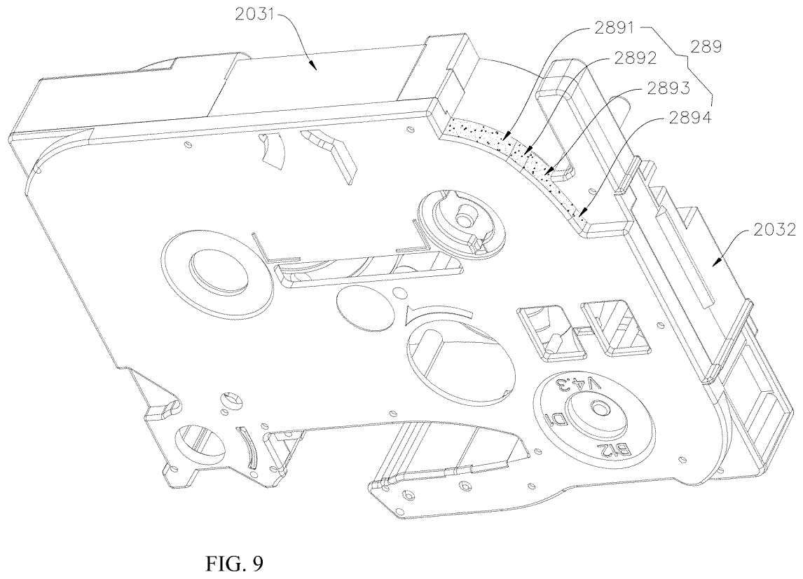

In addition, referring to FIG. 9, in the present embodiment, a first wall surface 289 on a surface of a first side wall of the first housing includes a first arc surface part 2891, a first planar part 2892, a second arc surface part 2893, and a second planar part 2894 that are sequentially bent and connected from a first end of the first wall surface 289 near a width side 2031 to a second end of the first wall surface 289 near a length side 2032. Under this setting, the first wall surface 289 extends continuously and tortuously in terms of a projection in the thickness direction.

In other embodiments, based on the first or second embodiment, the connecting pillar and the connecting hole are swapped between the first housing and the second housing. Specifically, there are several connecting holes on the outer peripheral surface of the first housing, which are set in a cylindrical shape to penetrate through. Correspondingly, there are connecting pillars on the second housing that correspond one-to-one with the connecting holes. An outer diameter of the connecting pillar is smaller than an inner diameter of the connecting hole, and the end of the connecting pillar is provided with a chamfered structure for easy insertion. Through the above settings, the reliability of the connection between the first housing and the second housing are improved.

In other embodiments, the overall shape of the arm body is a straight line shape, and both the first arm part and the second arm part adopt a cavity-housing structure. An inner cavity wall of the first arm part is provided with a first connecting pillar extending inward, and an inner cavity wall of the second arm part is provided with a first seating hole which is mated with the first connecting pillar. The first connecting pillar is fixedly connected to the first seating hole through a fitting method. The above structure fully utilizes the internal space of the arm body, and the strength of the connecting structure is improved.

In other embodiments, there is a predetermined distance between an extension ending end of the arm body and the width side of the housing in the width direction of the housing, and the predetermined distance is set to extend along the length direction of the arm body. This setting ensures installation allowance while avoiding possible interference between components.

In other embodiments, the bending part may extend along an inclined direction, forming an acute angle with the length direction of the housing, and a circular arc transition structure is provided at a transition area of the bending part. This structure optimizes a stress distribution at the bending part.

In other embodiments, the arm body includes a bending part, but the bending part is not connected with the identification pillar.

In other embodiments, buckles and protrusions are respectively provided on an exterior of the first arm part and an exterior of the second arm part, and the first arm part and the second arm part are connected by an engagement of the buckles and protrusions. This connection method is easy to assemble and disassemble, and has good stability.

Finally, it should be emphasized that the above are embodiments of the present disclosure and are not intended to limit the present disclosure. For those skilled in the art, the present disclosure may have various changes and modifications. Any modifications, equivalent substitutions, improvements, etc. made within the spirit and principles of the present disclosure should be included in the protection scope of the present disclosure.

1. A housing, comprising:
a first housing and a second housing which are connected to each other along a thickness direction of the housing;
wherein:
the housing is provided with a notch, the notch is provided on a width side of the housing and runs through both sides of the housing's thickness, the housing has an arm body and an identification pillar, wherein in a length direction of the housing, the arm body is adjacent to the notch, and at least one of the identification pillar protrudes from the arm body;
the first housing comprises a first arm part, the second housing comprises a second arm part, and the arm body is formed by connecting the first arm part and the second arm part along the thickness direction; and
at least one of the first arm part and the second arm part is configured as a cavity-housing structure,
the housing further comprises a first connecting pillar and a first seating hole;
wherein the first connecting pillar is connected to one of the first arm part and the second arm part, and the first seating hole is connected to the other of the first arm part and the second arm part, the first connecting pillar is mated with the first seating hole along the thickness direction, and both the first connecting pillar and the first seating hole are located inside the arm body.

2. The housing according to claim 1, wherein:
one of the first arm part and the second arm part is configured as a cavity-housing structure, and the other of the first arm part and the second arm part is configured as a wall panel.

3. (canceled)

4. The housing according to claim 1, further comprising a second connecting pillar and a second seating hole;
wherein the first housing comprises a first root part, the first root part is connected to an extension starting end of the first arm part, and the second housing comprises a second root part, the second root part is connected to an extension starting end of the second arm part; and
the second connecting pillar is connected to one of the first root part and the second root part, and the second seating hole is connected to the other of the first root part and the second root part, the second connecting pillar is mated with the second seating hole along the thickness direction, and both the second connecting pillar and the second seating hole are located inside the housing.

5. The housing according to claim 1, wherein:
an extension ending end of the arm body is configured as a bending part, the bending part extends towards a direction close to the notch relative to a base of the arm body.

6. The housing according to claim 2, wherein:
an extension ending end of the arm body is configured as a bending part, the bending part extends towards a direction close to the notch relative to a base of the arm body.

7. The housing according to claim 1, wherein:
an extension ending end of the arm body is configured as a bending part, the bending part extends towards a direction close to the notch relative to a base of the arm body.

8. The housing according to claim 4, wherein:
an extension ending end of the arm body is configured as a bending part, the bending part extends towards a direction close to the notch relative to a base of the arm body.

9. The housing according to claim 5, wherein:
at least one of the identification pillar protrudes from the bending part.

10. The housing according to claim 6, wherein:
at least one of the identification pillar protrudes from the bending part.

11. The housing according to claim 5, wherein:
the base extends along a width direction of the housing, and the bending part extends along the length direction of the housing.

12. The housing according to claim 6, wherein:
the base extends along a width direction of the housing, and the bending part extends along the length direction of the housing.

13. The housing according to claim 1, wherein:
the housing comprises a side wall, and the notch is formed between the side wall and the arm body, the side wall is extended in a distance in both a width direction and the length direction of the housing;
the housing comprises a connecting part, and a surface of the side wall, the connecting part, and the arm body are sequentially connected; and
the surface of the side wall, except for an area connected to the connecting part, is configured as a wall surface.

14. The housing according to claim 2, wherein:
the housing comprises a side wall, and the notch is formed between the side wall and the arm body, the side wall is extended in a distance in both a width direction and the length direction of the housing;
the housing comprises a connecting part, and a surface of the side wall, the connecting part, and the arm body are sequentially connected;
the surface of the side wall, except for an area connected to the connecting part, is configured as a wall surface.

15. The housing according to claim 1, wherein:
the housing comprises a side wall, and the notch is formed between the side wall and the arm body, the side wall is extended in a distance in both a width direction and the length direction of the housing;
the housing comprises a connecting part, and a surface of the side wall, the connecting part, and the arm body are sequentially connected;
the surface of the side wall, except for an area connected to the connecting part, is configured as a wall surface.

16. The housing according to claim 4, wherein:
the housing comprises a side wall, and the notch is formed between the side wall and the arm body, the side wall is extended in a distance in both a width direction and the length direction of the housing;
the housing comprises a connecting part, and a surface of the side wall, the connecting part, and the arm body are sequentially connected;
the surface of the side wall, except for an area connected to the connecting part, is configured as a wall surface.

17. The housing according to claim 13, wherein:
the width side is provided with a first right-angle part, and a first end of the wall surface is connected to the first right-angle part;
and/or,
a length side of the housing is provided with a second right-angle part, and a second end of the wall surface is connected to the second right-angle part.

18. The housing according to claim 17, wherein:
at least a part of the wall surface extends along a circular arc in terms of a projection in the thickness direction;
or,
at least a part of the wall surface extends continuously and tortuously in terms of a projection in the thickness direction.

19. The housing according to claim 17, wherein:
the housing is provided with a printing tape roll hole, and in terms of a projection in the thickness direction, the wall surface is provided on a periphery of the printing tape roll hole and covers an angle greater than or equal to 45 degrees.

20. A tape cartridge, comprising the housing according to claim 1.
